(19) United States
(12) Patent Application Publication
(10) Pub. No.: US 2024/0255016 A1
(43) Pub. Date: Aug. 1, 2024

(54) FASTENER SYSTEM FOR LEAK RESISTANT STRUCTURAL MEMBER ATTACHMENT

(71) Applicant: Andersen Corporation, Bayport, MN (US)

(72) Inventors: Paul Michael Allan Morris, Roseville, MN (US); Craig Michael Johnson, North Oaks, MN (US); Jared Asa Shanholtzer, Saint Paul Park, MN (US); Ross McGruder, Lake Elmo, MN (US); Jon Eric Dekko, Stillwater, MN (US)

(21) Appl. No.: 18/399,112

(22) Filed: Dec. 28, 2023

Related U.S. Application Data
(60) Provisional application No. 63/441,610, filed on Jan. 27, 2023.

(51) Int. Cl. F16B 43/00; E06B 3/968

(52) U.S. Cl. CPC F16B 43/001; E06B 3/9687

(57) ABSTRACT

Embodiments herein relate to structural assemblies for fenestration units including a fastener system for leak resistant structural member attachment. In an embodiment, a frame assembly for a fenestration unit is included having a first frame member and a second frame member, wherein the second frame member engages with the first frame member. The frame assembly further includes a leak resistant fastener assembly securing the second frame member to the first frame member. The leak resistant fastener assembly can include a threaded fastener, a shoulder element, a deformable sealing member, and a washer. Insertion of the threaded fastener into the first frame member and the second frame member causes the washer to compress the deformable sealing member forming a face seal and causes the shoulder of the threaded fastener to expand the deformable sealing member radially forming an edge seal. Other embodiments are also included herein.

This application claims the benefit of U.S. Provisional Application No. 63/441,610, filed Jan. 27, 2023, the content of which is herein incorporated by reference in its entirety.

### FIELD

Embodiments herein relate to fenestrations systems. More specifically, embodiments herein relate to structural assemblies for fenestration units including a fastener system for leak resistant structural member attachment.

### BACKGROUND

Fenestrations can include entry door systems, patio doors, windows and the like. Fenestrations generally include frame systems and/or other structural members for structural support. In many cases, fenestrations are installed in areas where they are exposed to water from the exterior environment. As such, fenestrations generally need to be designed to prevent water ingress.

### SUMMARY

Embodiments herein relate to structural assemblies for fenestration units including a fastener system for leak resistant structural member attachment. In a first aspect, a frame assembly for a fenestration unit can be included having a first frame member and a second frame member, wherein the second frame member engages with the first frame member. The frame assembly also includes a leak resistant fastener assembly, wherein the leak resistant fastener assembly secures the second frame member to the first frame member. The leak resistant fastener assembly also includes a threaded fastener with a shoulder element, a deformable sealing member, and a washer, wherein insertion of the threaded fastener into the first frame member and the second frame member causes the washer to compress the deformable sealing member forming a face seal and causes the shoulder of the threaded fastener to expand the deformable sealing member radially forming an edge seal.

In a second aspect, in addition to one or more of the preceding or following aspects, or in the alternative to some aspects, the deformable sealing member can include a barrel and a flange.

In a third aspect, in addition to one or more of the preceding or following aspects, or in the alternative to some aspects, the barrel can include a tapered barrel.

In a fourth aspect, in addition to one or more of the preceding or following aspects, or in the alternative to some aspects, the deformable sealing member can include an expandable portion and a compressible portion.

In a fifth aspect, in addition to one or more of the preceding or following aspects, or in the alternative to some aspects, the deformable sealing member can be formed of an elastomeric composition.

In a sixth aspect, in addition to one or more of the preceding or following aspects, or in the alternative to some aspects, the first frame member defines an aperture, wherein the threaded fastener passes through the aperture. The face seal can be formed between the leak resistant fastener assembly and the aperture and the edge seal can be formed between the leak resistant fastener assembly and the aperture.

In a seventh aspect, in addition to one or more of the preceding or following aspects, or in the alternative to some aspects, the first frame member can define a first aperture and a second aperture. The threaded fastener passes through both the first aperture and the second aperture. The face seal can be formed between the leak resistant fastener assembly and the first aperture.

In an eighth aspect, in addition to one or more of the preceding or following aspects, or in the alternative to some aspects, the edge seal can be formed between the leak resistant fastener assembly and the first aperture, the second aperture, or both the first aperture and the second aperture.

In a ninth aspect, in addition to one or more of the preceding or following aspects, or in the alternative to some aspects, the first frame member can include an aluminum portion and a composite portion. The first aperture can be within the aluminum portion and the second aperture can be within the composite portion.

In a tenth aspect, in addition to one or more of the preceding or following aspects, or in the alternative to some aspects, the first aperture can be a bottom aperture.

In an eleventh aspect, in addition to one or more of the preceding or following aspects, or in the alternative to some aspects, the second aperture can be a top aperture.

In a twelfth aspect, in addition to one or more of the preceding or following aspects, or in the alternative to some aspects, the second frame member engages with the first frame member perpendicularly.

In a thirteenth aspect, in addition to one or more of the preceding or following aspects, or in the alternative to some aspects, the first frame member defines a first aperture and a second aperture. The threaded fastener passes through the second aperture and not the first aperture. the first aperture being an access aperture. The face seal can be formed between the leak resistant fastener assembly and the first aperture.

In a fourteenth aspect, in addition to one or more of the preceding or following aspects, or in the alternative to some aspects, the washer can include a cup washer.

In a fifteenth aspect, in addition to one or more of the preceding or following aspects, or in the alternative to some aspects, the washer can include at least one selected from the group consisting of a metal washer and a polymeric washer.

In a sixteenth aspect, in addition to one or more of the preceding or following aspects, or in the alternative to some aspects, the threaded fastener and the washer can be physically integrated.

In a seventeenth aspect, in addition to one or more of the preceding or following aspects, or in the alternative to some aspects, the deformable sealing member can include a deformable sealing grommet.

In an eighteenth aspect, in addition to one or more of the preceding or following aspects, or in the alternative to some aspects, the threaded fastener further can include a shoulder screw.

In a nineteenth aspect, in addition to one or more of the preceding or following aspects, or in the alternative to some aspects, the first frame member can include a sill assembly.

In a twentieth aspect, in addition to one or more of the preceding or following aspects, or in the alternative to some aspects, the second frame member can include a mull post.

In a twenty-first aspect, in addition to one or more of the preceding or following aspects, or in the alternative to some aspects, the fenestration unit can be a window unit.

In a twenty-second aspect, in addition to one or more of the preceding or following aspects, or in the alternative to some aspects, the fenestration unit can be a door unit.

In a twenty-third aspect, a frame assembly for a fenestration unit can be included having a first frame member and a second frame member, wherein the second frame member engages with the first frame member. The frame assembly can also include a leak resistant fastener assembly, wherein the leak resistant fastener assembly secures the second frame member to the first frame member. The leak resistant fastener assembly can include a threaded fastener including a shoulder element, and a deformable sealing member, wherein insertion of the threaded fastener into the first frame member and the second frame member causes compression of the deformable sealing member forming a face seal and causes the shoulder of the threaded fastener to expand the deformable sealing member radially forming an edge seal.

In a twenty-fourth aspect, in addition to one or more of the preceding or following aspects, or in the alternative to some aspects, the deformable sealing member can include a barrel and a flange.

In a twenty-fifth aspect, in addition to one or more of the preceding or following aspects, or in the alternative to some aspects, the barrel can include a tapered barrel.

In a twenty-sixth aspect, in addition to one or more of the preceding or following aspects, or in the alternative to some aspects, the deformable sealing member can include: an expandable portion and a compressible portion.

In a twenty-seventh aspect, in addition to one or more of the preceding or following aspects, or in the alternative to some aspects, the deformable sealing member can be formed of an elastomeric composition.

In a twenty-eighth aspect, in addition to one or more of the preceding or following aspects, or in the alternative to some aspects, the first frame member defines an aperture, wherein the threaded fastener passes through the aperture and wherein the face seal and the edge seal can be formed between the leak resistant fastener assembly and the aperture.

In a twenty-ninth aspect, in addition to one or more of the preceding or following aspects, or in the alternative to some aspects, the first frame member defines a first aperture and a second aperture. The threaded fastener passes through both the first aperture and the second aperture and the face seal can be formed between the leak resistant fastener assembly and the first aperture.

In a thirtieth aspect, in addition to one or more of the preceding or following aspects, or in the alternative to some aspects, the edge seal can be formed between the leak resistant fastener assembly and the first aperture, the second aperture, or both the first aperture and the second aperture.

In a thirty-first aspect, in addition to one or more of the preceding or following aspects, or in the alternative to some aspects, the first frame member defines a first aperture and a second aperture. The threaded fastener passes through both the first aperture and the second aperture. The face seal and the edge seal can be formed between the leak resistant fastener assembly and the first aperture.

In a thirty-second aspect, in addition to one or more of the preceding or following aspects, or in the alternative to some aspects, the first frame member can include an aluminum portion and a composite portion. The first aperture can be within the aluminum portion and the second aperture can be within the composite portion.

In a thirty-third aspect, in addition to one or more of the preceding or following aspects, or in the alternative to some aspects, the first aperture can be a bottom aperture.

In a thirty-fourth aspect, in addition to one or more of the preceding or following aspects, or in the alternative to some aspects, the second aperture can be a top aperture.

In a thirty-fifth aspect, in addition to one or more of the preceding or following aspects, or in the alternative to some aspects, the first frame member defines a first aperture and a second aperture. The threaded fastener passes through the second aperture and not the first aperture and the face seal and the edge seal can be formed between the leak resistant fastener assembly and the second aperture.

In a thirty-sixth aspect, in addition to one or more of the preceding or following aspects, or in the alternative to some aspects, the deformable sealing member can include a deformable sealing grommet.

In a thirty-seventh aspect, in addition to one or more of the preceding or following aspects, or in the alternative to some aspects, the threaded fastener further can include a shoulder screw.

In a thirty-eighth aspect, in addition to one or more of the preceding or following aspects, or in the alternative to some aspects, the first frame member can include a sill assembly.

In a thirty-ninth aspect, in addition to one or more of the preceding or following aspects, or in the alternative to some aspects, the second frame member can include a mull post.

In a fortieth aspect, in addition to one or more of the preceding or following aspects, or in the alternative to some aspects, the fenestration unit can be a window unit.

In a forty-first aspect, in addition to one or more of the preceding or following aspects, or in the alternative to some aspects, the fenestration unit can be a door unit.

In a forty-second aspect, in addition to one or more of the preceding or following aspects, or in the alternative to some aspects, the second frame member intersects the first frame member perpendicularly.

In a forty-third aspect, a method of joining structural members of a fenestration unit is included. The method can include inserting a leak resistant fastener assembly into a first frame member and a second component. The leak resistant fastener assembly can include a threaded fastener with a shoulder element, a deformable sealing member, and a washer. The method can further include compressing the deformable sealing member forming a face seal and expanding the deformable sealing member radially forming an edge seal.

In a forty-fourth aspect, in addition to one or more of the preceding or following aspects, or in the alternative to some aspects, the first frame member can include a sill assembly.

In a forty-fifth aspect, in addition to one or more of the preceding or following aspects, or in the alternative to some aspects, the second component can include a second frame member.

In a forty-sixth aspect, in addition to one or more of the preceding or following aspects, or in the alternative to some aspects, the second frame member can include a mull post.

In a forty-seventh aspect, in addition to one or more of the preceding or following aspects, or in the alternative to some aspects, the second frame member can include a side jamb.

In a forty-eighth aspect, in addition to one or more of the preceding or following aspects, or in the alternative to some aspects, the fenestration unit can be an entry door.

In a forty-ninth aspect, a fenestration unit can be included having a door, a side unit, and a frame assembly. The frame assembly can include a first side jamb, a second side jamb, a head jamb, and a sill assembly. The frame assembly surrounds the door and the side unit. A mull post can be disposed between the door and the side unit. The sill assembly can include an internal water flow channel, wherein the internal water flow channel extends under both the door and the side unit.

In a fiftieth aspect, in addition to one or more of the preceding or following aspects, or in the alternative to some aspects, a portion of the internal water flow channel under the door can be in fluid communication with a portion of the internal water flow channel under the side unit.

In a fifty-first aspect, in addition to one or more of the preceding or following aspects, or in the alternative to some aspects, a portion of the internal water flow channel on one side of the mull post can be in fluid communication with a portion of the internal water flow channel on the other side the mull post.

In a fifty-second aspect, in addition to one or more of the preceding or following aspects, or in the alternative to some aspects, the sill assembly can define interior water flow apertures.

In a fifty-third aspect, in addition to one or more of the preceding or following aspects, or in the alternative to some aspects, the sill assembly can define water egress apertures, wherein the water egress apertures are disposed on an exterior side of the sill assembly.

In a fifty-fourth aspect, in addition to one or more of the preceding or following aspects, or in the alternative to some aspects, the side unit can include at least one selected from the group consisting of a side lite, a glazed-in-glass panel, a stationary panel, a secondary door unit.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic front elevation view of a fenestration unit in accordance with various embodiments herein.

FIG. 2 is a cross-sectional view of a portion of a frame assembly as taken along line 2-2′ of FIG. 1 in accordance with various embodiments herein.

FIG. 3 is a cross-sectional view of a sill assembly in accordance with various embodiments herein.

FIG. 4 is an exploded perspective view of a portion of a frame assembly in accordance with various embodiments herein.

FIG. 5 is a schematic view of a leak resistant fastener assembly in accordance with various embodiments herein.

FIG. 6 is a partial sectional view of a leak resistant fastener assembly as taken along line 6-6′ of FIG. 5 in accordance with various embodiments herein.

FIG. 7 is a perspective sectional view of a portion of a frame assembly in accordance with various embodiments herein.

FIG. 8 is a cross-sectional view of a leak resistant fastener assembly interfacing with part of a frame assembly in accordance with various embodiments herein.

FIG. 9 is a perspective view of a deformable sealing member in accordance with various embodiments herein.

FIG. 10 is a perspective view of a washer in accordance with various embodiments herein.

FIG. 11 is a cross-sectional view of a sill assembly mounted on an underlying structure in accordance with various embodiments herein.

FIG. 12 is a cross-sectional view of a sill assembly in accordance with various embodiments herein.

FIG. 13 is a front perspective view of a fenestration unit in accordance with various embodiments herein.

FIG. 14 is a perspective view of a fenestration unit in accordance with various embodiments herein.

FIG. 15 is a schematic front elevation view of a fenestration unit in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, fenestrations are frequently installed in areas where they are periodically exposed to water from the exterior environment. Therefore, fenestrations generally need to be designed to prevent water ingress. Fenestrations generally include frame systems and/or other structural members for structural support. Discrete pieces of such frame systems or other structural members generally must be fastened together. While conventional fasteners that penetrate into such frame systems or other structural members may provide sufficient structural integrity, they may also serve as points of potential water leakage.

Embodiments herein relate to frame assemblies or other structures for fenestration units including a fastener system for leak resistant structural member attachment. The fastener systems herein can provide a high level of structural integrity while also preventing potential water leakage.

As an example, a frame assembly for a fenestration unit herein can include a first frame member and a second components, such as a second frame member. The second frame member engages with the first frame member. In some cases the first frame member and the second frame member can intersect perpendicularly, but they can also intersect at various other angles. A leak resistant fastener assembly secures the second frame member to the first frame member. The leak resistant fastener assembly can include a threaded fastener including a shoulder element, a deformable sealing member, and optionally a washer. Insertion of the threaded fastener into the first frame member and the second frame member causes the washer to compress the deformable sealing member forming a face seal (such as between the deformable sealing member and a surface of the first frame member) and causes the shoulder of the threaded fastener to expand the deformable sealing member radially forming an edge seal (such as between the deformable sealing member and the edges of an aperture in the first frame member and/or in the second frame member). The face seal and the edge seal can work independently to prevent water leakage, but the combination of the face seal and the edge seal are highly effective to prevent water leakage (such as through an aperture in the first frame member through which the threaded fastener passes).

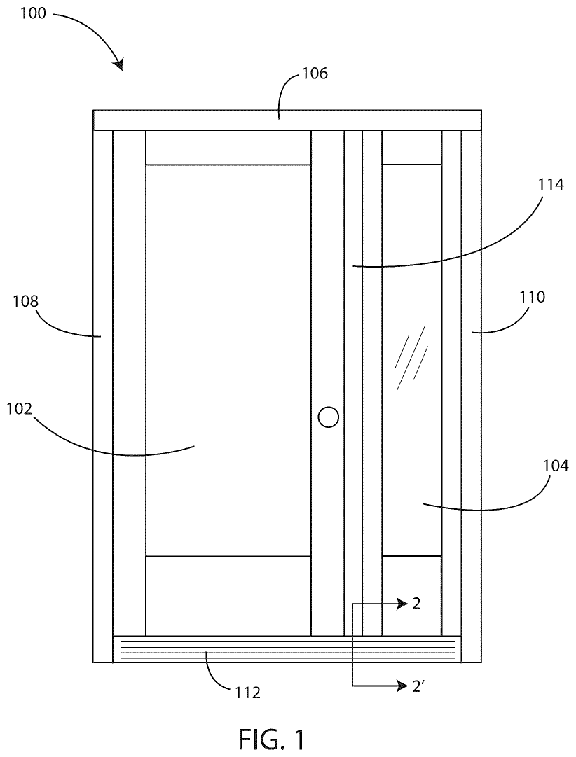

Referring now to FIG. 1, a schematic front elevation view of a fenestration unit 100 is shown in accordance with various embodiments herein. The fenestration unit 100 shown in FIG. 1 includes an entry door 102. However, other fenestration units are contemplated herein including, but not limited to, patio doors and windows. The particular fenestration unit 100 shown in FIG. 1 also includes a side lite 104. A frame assembly can include a head jamb 106, a first side jamb 108, a second side jamb 110, a sill assembly 112, and a mull post 114. The components of the frame assembly must be fastened together. Embodiments herein include fasteners that can fasten such components together with a high level of structural integrity and a high level of water leak resistance.

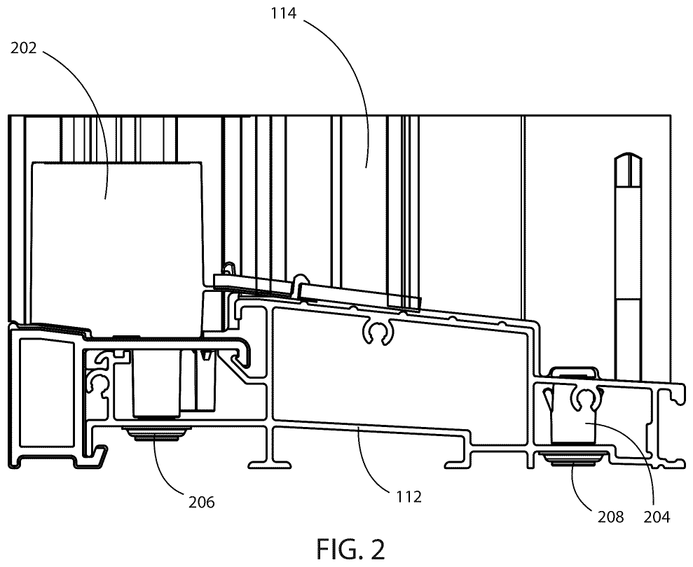

Referring now to FIG. 2, a cross-sectional view of a portion of a frame assembly as taken along line 2-2′ of FIG. 1 is shown in accordance with various embodiments herein. In this example, the frame assembly includes the mull post 114 fastened to the sill assembly 112. In this particular example, the frame assembly also includes a sill alignment key 202 and a screw standoff 204. Although, in some embodiments, the sill alignment key 202 and/or the screw standoff 204 may be omitted.

The frame assembly also includes a first leak resistant fastener assembly 206. The first leak resistant fastener assembly 206 passes through an aperture (not shown in this view) in the sill assembly 112 through the sill alignment key 202 and into the mull post 114. The frame assembly also includes a second leak resistant fastener assembly 208. The second leak resistant fastener assembly 208 passes through another aperture (not shown in this view) in the sill assembly 112, through the screw standoff 204, and into the mull post 114. As such, the first leak resistant fastener assembly 206 and the second leak resistant fastener assembly 208 secure a second frame member (in the form of a mull post in this example) to a first frame member (in the form of a sill assembly in this example).

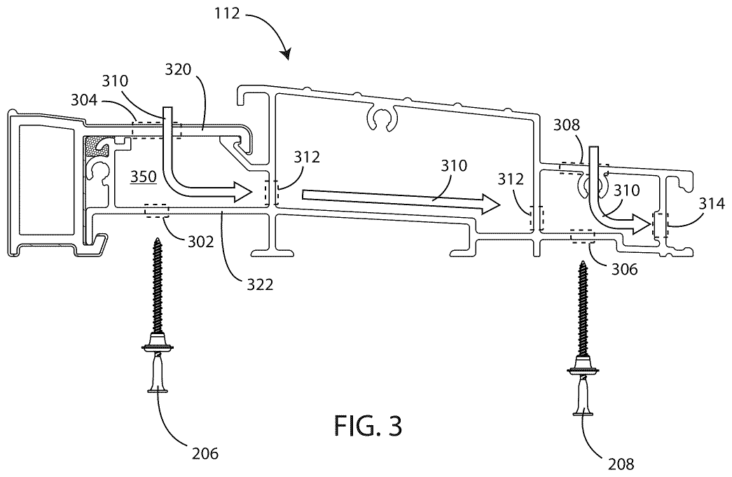

In some embodiments herein, a frame member for fastening may include one or more water flow channels therein. In such a case, the fasteners herein can be used to fasten one frame member to another frame member passing through apertures wherein one of the apertures must be watertight, but another may not be. For example, referring now to FIG. 3, a cross-sectional view of a sill assembly 112 is shown in accordance with various embodiments herein. The frame assembly includes a first leak resistant fastener assembly 206 and a second leak resistant fastener assembly 208. A first frame member (such as a sill assembly 112) may include a first aperture 302 and a second aperture 304. The first aperture 302 and the second aperture 304 can be defined by different walls of the sill assembly 112, such as a bottom wall and a top wall or the like. The first aperture 302 and the second aperture 304 can be aligned with one another with an open area in between. The first frame member may also include a third aperture 306 and a fourth aperture 308.

The first frame member includes internal passages 350 and defines a water flow path 310. The water flow path 310 can be used to direct water to the exterior of the fenestration unit, such as by passing from the top side of the sill through water drains into the interior of the sill assembly 112. The water can even pass through the second aperture 304 and fourth aperture 308 into the interior of the sill assembly 112. Once inside the sill assembly 112, the water can pass through one or more internal water flow apertures 312 (which can be placed at various points along the lengthwise axis of the sill assembly 112) before exiting harmlessly to the outside of a structure through a water egress aperture 314. However, as can be seen, the first aperture 302 and the third aperture 306 need to remain watertight so that water does not leak under the sill assembly 112. While the water flow path 310 is shown along an interior side to exterior side axis, the internal passages 350 within the frame member can extend along a lengthwise axis of the sill assembly 112 and water can flow through the internal passages 350. As such, should particular internal water flow apertures 312 become blocked, the water can move through internal passages 350 along the lengthwise axis of the sill assembly and then exit out other internal water flow apertures 312.

In various embodiments, a first leak resistant fastener assembly 206 passes through both the first aperture 302 (or bottom aperture) and the second aperture 304 (or top aperture). A face seal is formed between the first leak resistant fastener assembly 206 and the surface of the frame member surrounding the first aperture 302. In various embodiments, an edge seal is formed between a leak resistant fastener assembly and the edges of first aperture 302. The face seal and the edge seal can both, independently, render the first aperture 302 leak proof.

In various embodiments, the first frame member can include a first portion 320 and a second portion 322. The first portion 320 and the second portion 322 can be made of dissimilar materials. For example, in some embodiments, the first portion can be formed of a polymer and/or a composite and the second portion can be formed of a metal such as aluminum. In some embodiments, the first aperture 302 can be within an aluminum portion and the second aperture 304 can be within a composite portion. Regardless, the first aperture 302 can be rendered leak proof while the second aperture 304 can allow for water passage. Alternatively, in some embodiments, the second aperture 304 can also be rendered leak proof. For example, a portion of the leak resistant fastener assembly (such as the deformable sealing member) can be long enough to extend into the second aperture 304 such that an edge seal is also formed there rendering the second aperture 304 leak proof as well. Alternatively, in some embodiments only the second aperture 304 is leak proof and the first aperture 302 allows the passage of water. Many different variations are contemplated herein.

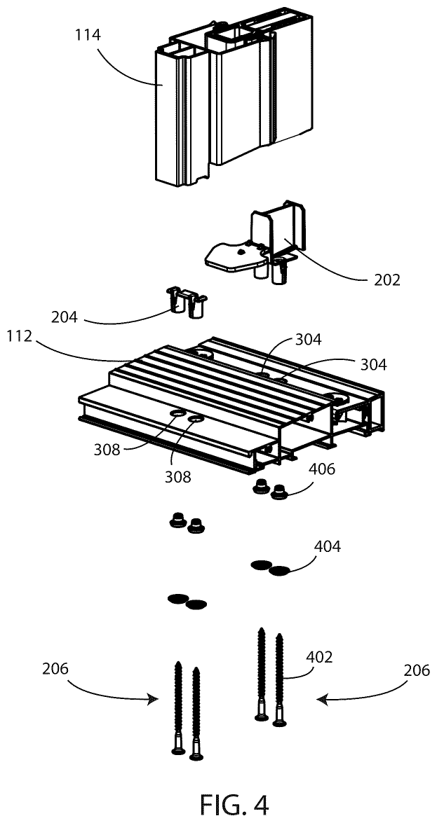

Referring now to FIG. 4, an exploded perspective view is shown of a portion of a frame assembly in accordance with various embodiments herein. As before, the frame assembly includes a first frame member (in the form of a sill assembly 112) and a second frame member (in the form of a mull post 114). Also, as before, the frame assembly includes a sill alignment key 202 and a screw standoff 204. The frame assembly also includes a first leak resistant fastener assembly 206. The first leak resistant fastener assembly 206 includes a threaded fastener 402, a washer 404, and a deformable sealing member 406. This view also shows the top side of the sill assembly 112 including the second aperture(s) 304 and the fourth aperture(s) 308.

In various embodiments, insertion of a threaded fastener 402 into a first frame member and a second frame member causes the washer 404 to compress the deformable sealing member 406 forming a face seal. The shoulder of the threaded fastener 402 pushes into the deformable sealing member 406 causing it to expand radially forming an edge seal. In various embodiments, the threaded fastener 402 and a washer 404 are separate components. However, in some embodiments, the threaded fastener 402 and a washer 404 are physically integrated. In some embodiments, a discrete washer may be omitted and the fastener head may be shaped and/or configured to provide compression of the deformable sealing member 406.

The threaded fastener 402 can be formed of many different materials. In some embodiments, the threaded fastener 402 can include a metal. In various embodiments, the metal can include or be an elemental metal or an alloy. In various embodiments, the metal can include one or more of aluminum, titanium, magnesium, chromium, iron, nickel, zinc, or alloys including any of these.

The washer 404 can also be formed of many different materials. In some embodiments, the washer 404 can include a polymer, a composite, or a metal. Such a polymer could be thermoplastic or a thermoset. In various embodiments, a metal for the washer 404 can include or be an elemental metal or a metal alloy. In various embodiments, the metal or alloy can include one or more of aluminum, titanium, chromium, nickel, zinc, iron, magnesium, and the like.

The deformable sealing member 406 can be formed of many different materials. In some embodiments, the deformable sealing member 406 can include a polymer. In various embodiments, the polymer can include or be an elastomeric polymer. Synthetic or natural materials can be used, such as synthetic or natural rubber. The deformable sealing member 406 can have various durometer values.

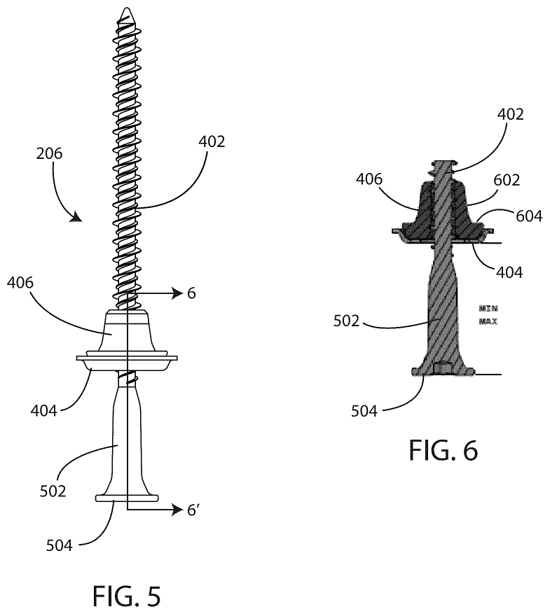

Referring now to FIG. 5, a schematic view of a leak resistant fastener assembly is shown in accordance with various embodiments herein. As before, the leak resistant fastener assembly can include a threaded fastener 402, a washer 404, and a deformable sealing member 406. The threaded fastener 402 can include a shoulder element 502 and a screw head 504. The shoulder element 502 can have a diameter that is larger than the core diameter or inner diameter of the threaded area. In this way, the shoulder element 502 can push outward on a material it passes through, such as the deformable sealing member 406. The shoulder element 502 can be of various lengths, such as greater than or equal to 5, 10, 15, 20, 25, 30, 40, 50, 60, 70, 80 or 90 percent of the overall length of the fastener, or a length falling within a range between any of the foregoing. The action of the shoulder element 502 pushing outward can cause the deformable sealing member 406 and/or portions thereof to deform and expand radially outward.

Referring now to FIG. 6, a partial sectional view of a leak resistant fastener assembly as taken along line 6-6′ of FIG. 5 is shown in accordance with various embodiments herein. The leak resistant fastener assembly includes a threaded fastener 402 with a shoulder element 502. The threaded fastener 402 also includes a screw head 504. The first leak resistant fastener assembly also includes a washer 404. As described previously, in some embodiments a discrete washer 404 may be omitted and the screw head 504 can be shaped and/or configured to take on some functions of the washer.

The leak resistant fastener assembly also includes a deformable sealing member 406. The deformable sealing member 406 can include a flange 604 portion. The deformable sealing member 406 can also include a barrel 602, such as a tapered barrel. The flange 604 portion can have a larger outside diameter than the barrel 602. The flange 604 can be configured to remain outside of an aperture into which the fastener assembly is inserted and form a face seal with an outer surface of the material in which the aperture is located. In contrast, the barrel 602 or a portion thereof can pass through the aperture and then be expanded radially by insertion of the shoulder portion of the fastener such that the barrel 602 forms an edge seal with the edges of the aperture. The diameter of the barrel 602 can expand radially by about 0.5, 1, 2, 3, 4, 5, 7.5, 10, 15, 20 or 30 percent or more, or an amount falling within a range between any of the foregoing. The deformable sealing member 406 can have a length that is greater than or equal to 5, 10, 15, 20, 25, 30, 40, 50, 60, 70, 80 or 90 percent of the overall length of the fastener, or a length falling within a range between any of the foregoing.

In many embodiments, the threaded fastener 402 is a screw. However, in some embodiments, the threaded fastener 402 can also be a bolt. In some embodiments, the threaded fastener can even be replaced with a non-threaded fastener.

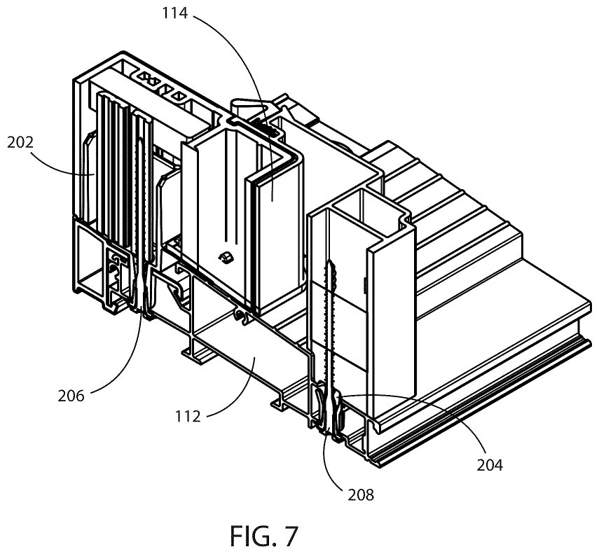

Referring now to FIG. 7, a perspective sectional view of a portion of a frame assembly is shown in accordance with various embodiments herein. As before, the frame assembly includes a sill assembly 112, a mull post 114, a sill alignment key 202, a screw standoff 204, a first leak resistant fastener assembly 206, and a second leak resistant fastener assembly 208.

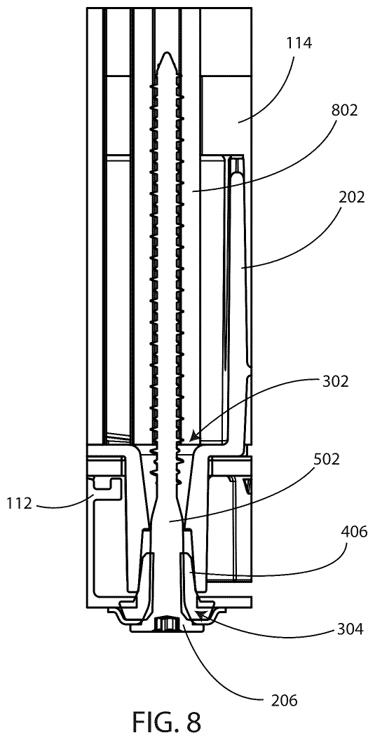

Referring now to FIG. 8, a cross-sectional view of a leak resistant fastener assembly interfacing with part of a frame assembly is shown in accordance with various embodiments herein. As before, the frame assembly includes a sill assembly 112, a mull post 114, a sill alignment key 202, and a first leak resistant fastener assembly 206. The first leak resistant fastener assembly 206 includes a deformable sealing member 406. the threaded fastener of the first leak resistant fastener assembly 206 includes a shoulder element 502. The mull post 114 also includes a screw chase 802. The sill assembly 112 includes a first aperture 302 and a second aperture 304.

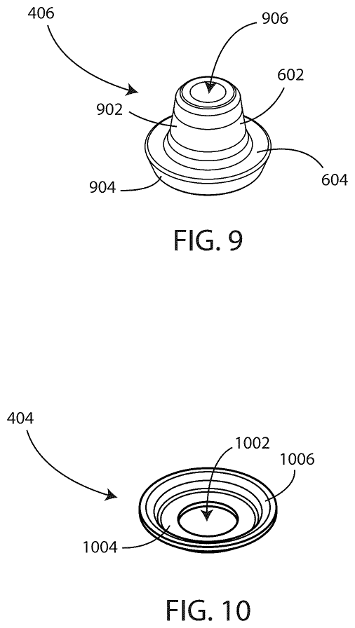

Referring now to FIG. 9, a perspective view of a deformable sealing member 406 is shown in accordance with various embodiments herein. The deformable sealing member 406 includes a flange 604 and a barrel 602. The deformable sealing member 406 also includes an expandable portion 902. The deformable sealing member 406 also includes a compressible portion 904. The deformable sealing member 406 also includes a lumen 906 or passageway for the fastener and a barrel 602, such as a tapered barrel. In various embodiments, the deformable sealing member 406 can take the form of a deformable sealing grommet.

Referring now to FIG. 10, a perspective view of a washer 404 is shown in accordance with various embodiments herein. The washer 404 includes a central aperture 1002. The washer 404 also includes a washer ring 1004. The washer 404 also includes a cup 1006. In various embodiments, the washer 404 can be a cup washer.

While other embodiments previous illustrated feature fasteners passing upward through two apertures to secure structural members together while preventing water leakage, it will be appreciated that many other implementations are contemplated herein. In some embodiments, the fasteners can pass downward through various materials. Further, in some embodiments, the fastener assembly may not remain within one or more apertures after installation. For example, an aperture may serve simply as an access aperture and the fastener assembly can be inserted there through, but not pass through (remain present in) the aperture after installation. In some embodiments, the leak resistant fastener assembly (and/or components thereof) can pass through one, two, three, four, or more apertures.

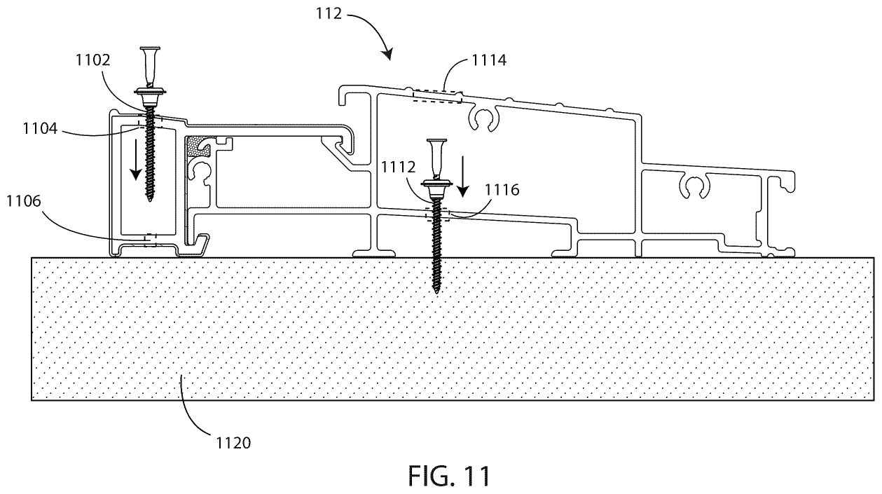

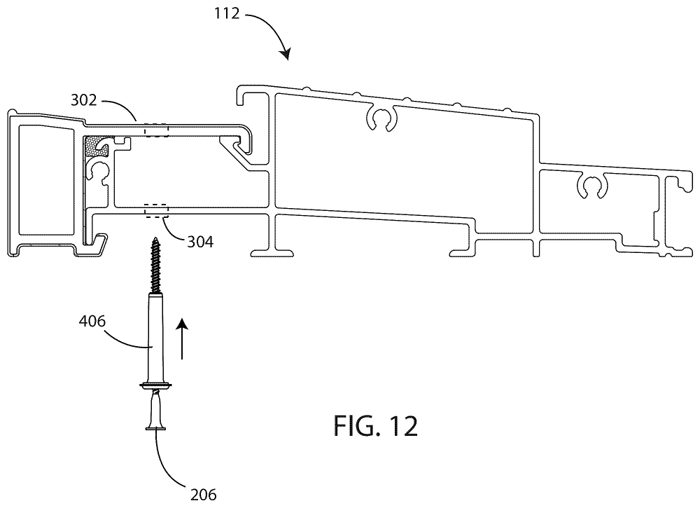

Referring now to FIG. 11, a cross-sectional view of a sill assembly 112 mounted on an underlying structure 1120 is shown in accordance with various embodiments herein. A first frame member in the form of a sill assembly 112 is shown disposed on an underlying structure 1120. The underlying structure can include various different components such as a rough opening, a subfloor, a concrete slab, a rim joist or the like

In this example, a first leak resistant fastener assembly 1102 can pass downward through a first aperture 1104 (with which an edge seal is formed) and a second aperture 1106 and into the underlying structure 1120. After full insertion, the first leak resistant fastener assembly 1102 also forms a face seal with the top surface of the sill assembly 112.

Also shown in FIG. 11, a second leak resistant fastener assembly 1112 can be inserted downward through a third aperture 1114 (which serves as an access aperture), but not remain therein, and pass through a fourth aperture 1116 and into the underlying structure 1120. After full insertion, the second leak resistant fastener assembly 1112 forms a face seal with an inner top surface of the sill assembly 112 (surrounding the fourth aperture 1116) and an edge seal with the edges of the fourth aperture 1116.

While various embodiments herein show examples of fasteners passing through two or more separate apertures (such as may be formed in a single structural member that has two or more separate walls or more than one structural member interfacing with one another) it will be appreciated that embodiments of leak resistant fastener assemblies herein can also be used with scenarios where there is a single aperture in a single wall, such as with a plate having an aperture therein that is fastened to a structural member.

In some embodiments, the deformable sealing member of the leak resistant fastener assembly can be long enough to engage with and form edge seals with two or more different apertures. For example, referring now to FIG. 12, a cross-sectional view of a sill assembly 112 is shown in accordance with various embodiments herein. The leak resistant fastener assembly 206 includes a deformable sealing member 406 that is sufficiently long to engage with first aperture 302 and second aperture 304. Thus, after a fastener is inserted with a sufficiently long shoulder section, an edge seal can be formed with both the first aperture 302 and second aperture 304.

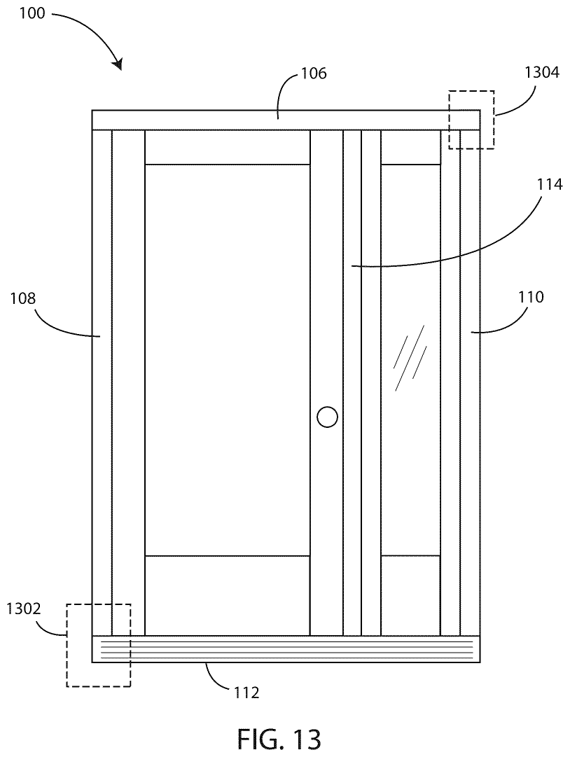

It will be appreciated that various different structural members can be fastened together using leak resistant fastener assemblies herein. For example, referring now to FIG. 13, a front perspective view of a fenestration unit 100 is shown in accordance with various embodiments herein. FIG. 13 is generally similar to FIG. 1 and shows a frame assembly with a head jamb 106, a first side jamb 108, a second side jamb 110, a sill assembly 112, and a mull post 114. However, in this example, a joint 1302 between the first side jamb 108 and the sill assembly 112 is fastened using one or more leak resistant fastener assemblies in accordance with embodiments herein. In addition, a joint 1304 between the head jamb 106 and the second side jamb 110 is fastened using one or more leak resistant fastener assemblies in accordance with embodiments herein.

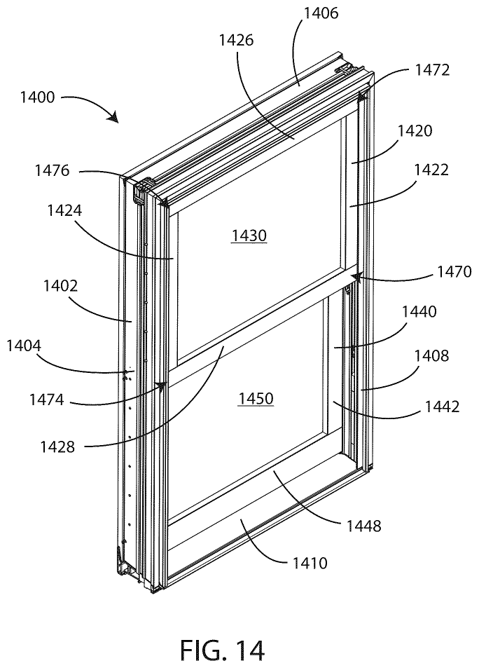

As discussed previously, fenestrations herein can include entry doors, patio doors, windows, and the like. Referring now to FIG. 14, a perspective view of a fenestration unit 1400 is shown in accordance with various embodiments herein. The fenestration unit 1400 includes a frame assembly 1402. The frame assembly 1402 includes a first side jamb 1404, a head jamb 1406, a second side jamb 1408, and a sill 1410. In various embodiments the first side jamb 1404, head jamb 1406, second side jamb 1408, and sill 1410 can be lineal extrusions formed of materials described in greater detail below. Any members of the frame assembly can be joined together using leak resistant fastener assemblies herein.

In the example, of FIG. 14, the fenestration unit 1400 is a window and, specifically, a double-hung window. However, it will be appreciated that various features described herein can also be incorporated within other types of windows as well as doors, such as patio doors. For example, features herein can also be applied to designs for single-hung, casement, awning, sliding, and picture windows amongst others.

The fenestration unit 1400 shown in FIG. 14 includes a top sash 1420. The top sash 1420 includes a first stile 1422, a second stile 1424, a top rail 1426, and a check rail 1428. The top sash 1420 forms a first lower corner 1470, a first upper corner 1472, a second lower corner 1474, and a second upper corner 1476.

In various embodiments the first stile 1422, second stile 1424, top rail 1426, and check rail 1428 can be lineal extrusions. In the context of a double-hung window, the top sash 1420 can slide up and down within the frame assembly 1402. The top sash 1420 includes a glass subassembly 1430 therein. The fenestration unit 1400 also includes a bottom sash 1440. The bottom sash 1440 includes a first stile 1442 and a second stile (not shown in this view). The bottom sash 1440 also includes a bottom rail 1448 and a check rail (not shown in this view). In various embodiments, the bottom rail 1448 of the bottom sash 1440 can be taller than the other rails, such as those of the top sash 1420, and is sometimes referred to as a “tall bottom rail”. The bottom sash 1440 also includes a glass subassembly 1450. Any components of the sashes can be joined together using leak resistant fastener assemblies herein.

In some embodiments, fenestration units (such as an entry door system) can be included herein that have a sill assembly with an internal water flow channel that extends under both the door and an adjacent side lite and/or side panel. For example, a fenestration unit can be included having a door, a side lite and/or a side panel, and a frame assembly. The frame assembly can include a first side jamb, a second side jamb, a head jamb, and a sill assembly, wherein the frame assembly surrounds the door and the side lite and/or a side panel. A mull post can also be included, wherein the mull post is disposed between the door and the side lite and/or a side panel. The sill assembly can include an internal water flow channel that can extend under both the door and the side lite and/or a side panel.

While not intending to be bound by theory, such extended water flow channels can be advantageous, particularly in the context of entry doors. Entry door systems may result in more water being captured in the sill assembly than in other types of fenestration systems. Further, entry door systems may include a joint between a mull post and the sill assembly, such as that shown in FIG. 2 which may also lead to additional water capture. By having an extended water flow channel, should particular internal water flow apertures or water egress apertures become blocked, the water can still move through internal passages along the lengthwise axis of the sill assembly and then exit out other internal water flow apertures. As such, the ability to allow water to move through the sill assembly along its full distance and/or out of the sill assembly to the exterior at any point can be particularly significant as the joint between the mull post and the sill assembly can allow for water to pass into the sill assembly.

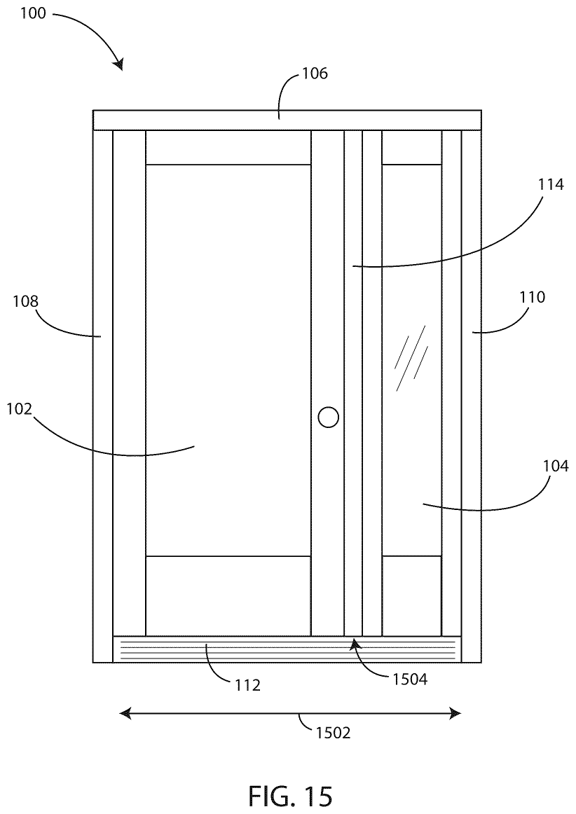

Referring now to FIG. 15, a schematic front elevation view of a fenestration unit 100 is shown in accordance with various embodiments herein. The fenestration unit 100 shown in FIG. 15 includes an entry door 102 (or active door panel) and a side lite 104 (as an example of a side unit). Various embodiments herein can include door systems with mull posts in between units, such as in between an active door panel and a side unit (such as a stationary panel, side lite, glazed-in-glass panel, stationary door, etc.). A frame assembly can include a head jamb 106, a first side jamb 108, a second side jamb 110, a sill assembly 112, and a mull post 114. In this embodiment, the sill assembly 112 extends a length 1502 that extends under both the entry door 102 and the side lite 104. In particular, the sill assembly 112 can form a joint 1504 with the mull post 114, wherein the mull post 114 is disposed between the entry door 102 and the side lite 104.

As described with respect to FIG. 3, the sill assembly 112 can include internal passages and define a water flow path. The water flow path can be used to direct water to the exterior of the fenestration unit, such as by passing from the top side of the sill through water drains into the interior of the sill assembly 112. Once inside the sill assembly 112, the water can pass through one or more internal water flow apertures (which can be placed at various points along the lengthwise axis of the sill assembly 112) before exiting harmlessly to the outside of a structure through a water egress aperture. The internal passages within the sill assembly 112 can extend along a lengthwise axis of the sill assembly 112 and water can flow through the internal passages. As such, should particular internal water flow apertures or water egress apertures become blocked, the water can move through internal passages along the lengthwise axis of the sill assembly and then exit out other internal water flow apertures. This ability to allow water to move through sill assembly then out of the sill assembly to the exterior can be particularly significant as the joint 1504 between the mull post 114 and the sill assembly 112 can allow for water to pass into the sill assembly as described with respect to FIG. 3. The mull post 114 can be joined to the sill assembly 112 using a leak resistant fastener assembly described herein.

In various embodiments, all water flow channels/pathways within the sill assembly 112 are in fluid communication with one another. In various embodiments, water flow channels/pathways in the sill assembly 112 on one side of a mull post 114 are in fluid communication with water flow channels/pathways on the other side of the mull post 114.

While FIG. 15 shows a single mull post, it will be appreciated that in some embodiments more than one mull post can be included (such as two, three, or more). For example, a fenestration unit herein could include an active door panel (such as an in-swing entry door) along with various side units such as a side lite, a glazed-in-glass panel, a stationary panel, a secondary door unit, etc. (in various combinations) on one or both sides of the active door panel. In such embodiments, the sill assembly 112 and internal passages therein can extend along a lengthwise axis under all of the included units and therefore under multiple mull posts.

### Methods

Many different methods are contemplated herein, including, but not limited to, methods of making, methods of using, methods of fastening one component to another component, methods of preventing water leaks, and the like. Aspects of system/device operation described elsewhere herein can be performed as operations of one or more methods in accordance with various embodiments herein.

In an embodiment, a method of joining structural members of a fenestration unit is included. The method can include inserting a leak resistant fastener assembly into a first frame member and a second component (such as a second frame member). The leak resistant fastener assembly can include a threaded fastener with a shoulder element, a deformable sealing member, and a washer. The method can include compressing the deformable sealing member forming a face seal. The method can further include expanding the deformable sealing member radially forming an edge seal.

In an embodiment, the first frame member can include a sill assembly. In an embodiment, the second component can include a second frame member. In an embodiment, the second frame member can include a mull post. In an embodiment, the second frame member can include a side jamb.

In an embodiment of the method, the fenestration unit is an entry door. However, in some embodiments, the fenestration unit can include a patio door or a window.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A frame assembly for a fenestration unit comprising:
a first frame member;
a second frame member, wherein the second frame member engages with the first frame member; and
a leak resistant fastener assembly, wherein the leak resistant fastener assembly secures the second frame member to the first frame member, the leak resistant fastener assembly comprising
a threaded fastener, the threaded fastener comprising a shoulder element;
a deformable sealing member;
a washer; and
wherein insertion of the threaded fastener into the first frame member and the second frame member causes the washer to compress the deformable sealing member forming a face seal and causes the shoulder of the threaded fastener to expand the deformable sealing member radially forming an edge seal.

2. The frame assembly for the fenestration unit of claim 1, the deformable sealing member comprising:
a barrel; and
a flange.

3. The frame assembly for the fenestration unit of claim 2, the barrel comprising a tapered barrel.

4. The frame assembly for the fenestration unit of claim 1, the deformable sealing member comprising:
an expandable portion; and
a compressible portion.

5. The frame assembly for the fenestration unit of claim 1, wherein the deformable sealing member is formed of an elastomeric composition.

6. The frame assembly for the fenestration unit of claim 1, the first frame member defining an aperture;
wherein the threaded fastener passes through the aperture;
wherein the face seal is formed between the leak resistant fastener assembly and the aperture; and
wherein the edge seal is formed between the leak resistant fastener assembly and the aperture.

7. The frame assembly for the fenestration unit of claim 1, the first frame member
defining a first aperture; and
defining a second aperture;
wherein the threaded fastener passes through both the first aperture and the second aperture; and
wherein the face seal is formed between the leak resistant fastener assembly and the first aperture.

8. The frame assembly for the fenestration unit of claim 7, wherein the edge seal is formed between the leak resistant fastener assembly and the first aperture, the second aperture, or both the first aperture and the second aperture.

9. The frame assembly for the fenestration unit of claim 7, the first frame member comprising:
an aluminum portion; and
a composite portion, wherein the first aperture is within the aluminum portion and the second aperture is within the composite portion.

10. The frame assembly for the fenestration unit of claim 7, wherein the first aperture is a bottom aperture.

11. The frame assembly for the fenestration unit of claim 7, wherein the second aperture is a top aperture.

12. The frame assembly for the fenestration unit of claim 1, wherein the second frame member engages with the first frame member perpendicularly.

13. The frame assembly for the fenestration unit of claim 1, the first frame member
defining a first aperture; and
defining a second aperture;
wherein the threaded fastener passes through the second aperture and not the first aperture, the first aperture being an access aperture; and
wherein the face seal is formed between the leak resistant fastener assembly and the first aperture.

14. The frame assembly for the fenestration unit of claim 1, the washer comprising a cup washer.

15. The frame assembly for the fenestration unit of claim 1, the washer comprising at least one selected from the group consisting of a metal washer and a polymeric washer.

16. The frame assembly for the fenestration unit of claim 1, wherein the threaded fastener and the washer are physically integrated.

17. The frame assembly for the fenestration unit of claim 1, the deformable sealing member comprising a deformable sealing grommet.

18. The frame assembly for the fenestration unit of claim 1, the threaded fastener further comprising a shoulder screw.

19. The frame assembly for the fenestration unit of claim 1, the first frame member comprising a sill assembly.

20. The frame assembly for the fenestration unit of claim 1, the second frame member comprising a mull post.

21-54. (canceled)
